(19) United States
(12) Patent Application Publication
(10) Pub. No.: US 2025/0014131 A1
(43) Pub. Date: Jan. 9, 2025

(54) METHOD AND SYSTEM FOR GENERATING LEGAL SERVICE LEADS

(71) Applicant: FASTFORWARDUSA LLC, BONITA SPRINGS, FL (US)

(72) Inventors: Joel Douglas, Bonita Springs, FL (US); Shem Lachhman, West Harrison, NY (US); Thomas Ciesco, Northford, CT (US); Nicolas OConnell, North Reading, MA (US)

(21) Appl. No.: 18/764,433

(22) Filed: Jul. 5, 2024

Related U.S. Application Data
(60) Provisional application No. 63/512,268, filed on Jul. 6, 2023.

(51) Int. Cl. G06Q 50/18; G06Q 30/0241

(52) U.S. Cl. CPC G06Q 50/184; G06Q 30/0276

(57) ABSTRACT

The present disclosure provides a method for generating legal service leads. The method includes receiving an advertisement for a low-priced intellectual property service on a user device, responding to the advertisement through a data input application that guides the user through a do-it-yourself (DIY) data entry for the desired service, checking the inputted information and paying the associated service and filing fees, selecting a service provider through the system, reviewing the inputted information by the service provider, and submitting the inputted information by the service provider. The method may further include sending a notification to the user with the name and contact information of the selected service provider and the filed documents. The service provider may become the attorney or agent of record and receive any notice to respond to any office action generated by the filing.

### CROSS-REFERENCE TO RELATED APPLICATIONS

This application claims the benefit of U.S. Provisional Patent Application No. 63/512,268, filed on Jul. 6, 2023, which is incorporated by reference herein in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicant, make no claim to any trademarks referenced.

### BACKGROUND OF THE INVENTION

### 1) Field of the Invention

The invention relates to the field of lead generation systems and methods, and more particularly to an apparatus and method for generating and developing a sales lead for legal services, specifically in the field of intellectual property services.

### Description of Related Art

Currently the state of the art of legal services, particularly intellectual property services such as patent, copyright, or trademark filings, the generation of sales leads is a common and often challenging task. Sales leads are potential customers who have shown interest in a service and are considered likely to make a purchase. The process of generating these leads often involves advertising, direct marketing, and other promotional activities. However, these methods can be expensive and time-consuming, and they do not guarantee that the leads generated will result in actual sales.

One of the challenges in generating sales leads for legal services is the complexity and specificity of the services offered. Unlike products that can be easily described and marketed to a broad audience, legal services often require a detailed understanding of the client's specific situation and legal requirements. This makes it difficult to generate leads through traditional advertising methods, as the potential client may not fully understand the services being offered or may not yet be ready to make a decision.

Furthermore, the process of converting a lead into a client can be lengthy and uncertain. Potential clients often take a considerable amount of time to decide on a service provider, and they may choose to consult with multiple providers before making a decision. This can result in a high cost per lead, as the service provider has to invest time and resources in pursuing leads that may not ultimately result in a sale.

In addition, the traditional model of lead generation often involves the service provider paying for leads, either through advertising costs or through fees charged by lead generation services. This can be a substantial expense, particularly for smaller service providers or those in competitive markets.

In particular there is a need for a solution to at least one of the aforementioned problems. For instance, there is a general interest in the field of legal services for improved methods and systems for generating sales leads, particularly those that can reduce costs, increase efficiency, and improve the likelihood of converting leads into clients.

### BRIEF SUMMARY OF THE INVENTION

The instant invention in one form is directed to the generation of sales leads for legal services, particularly intellectual property services such as patent, copyright, or trademark filings.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for generating legal service leads is provided. The method includes receiving an advertisement for a low-priced intellectual property service on a user device. The user responds to the advertisement through a data input application that guides the user through a do-it-yourself (DIY) data entry for the desired service. The user checks the inputted information and pays the associated service and filing fees. A service provider is selected through the system, who then reviews the inputted information and submits it.

According to other aspects of the present disclosure, the low-priced intellectual property service may be a patent filing, copyright filing, or trademark filing. The data input application may utilize artificial intelligence to guide the user through the DIY data entry. The method may further include sending a notification to the user with the name and contact information of the selected service provider and the filed documents. The service provider may become the attorney or agent of record and receive any notice to respond to any office action generated by the filing. The method may also include providing a nominal payment to the service provider for their filing services.

According to another aspect of the present disclosure, a system for generating legal service leads is provided. The system includes a user device configured to receive an advertisement for a low-priced intellectual property service. A data input application is configured to guide the user through a do-it-yourself (DIY) data entry for the desired service. A payment module is configured to process the associated service and filing fees. A service provider selection module is configured to select a service provider, and a submission module is configured to enable the service provider to review and submit the inputted information.

According to other aspects of the present disclosure, the user device may be a smartphone, a tablet, a laptop, or a desktop computer. The data input application may utilize artificial intelligence to guide the user through the DIY data entry. The system may further include a notification module configured to send a notification to the user with the name and contact information of the selected service provider and the filed documents. The service provider may become the attorney or agent of record and receive any notice to respond to any office action generated by the filing. The system may also include a payment module configured to provide a nominal payment to the service provider for their filing services. The low-priced intellectual property service may be a patent filing, copyright filing, or trademark filing.

According to yet another aspect of the present disclosure, a computer-implemented method for generating legal service leads is provided. The method includes broadcasting an advertisement for a low-priced intellectual property service, receiving a response to the advertisement from a user device, guiding the user through a do-it-yourself (DIY) data entry for the desired service via a data input application, processing the associated service and filing fees, selecting a service provider from a list of subscribed service providers, and enabling the service provider to review and submit the inputted information.

According to other aspects of the present disclosure, the advertisement may be broadcasted through a medium such as television, radio, internet, social media platforms, or email. The data input application may include a user interface configured to receive the user's inputted information. The user interface may be configured to provide prompts to the user to guide the user through the DIY data entry. The method may further include the step of the service provider uploading a filing receipt to the system after submitting the inputted information. The system may be configured to send a notification to the user upon receipt of the filing receipt from the service provider. The service provider may be selected based on criteria including geographical location, expertise in the specific area of intellectual property service, and availability.

The foregoing general description of the illustrative embodiments and the following detailed description thereof are merely exemplary aspects of the teachings of this disclosure and are not restrictive.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a flow chart of the system of the instant invention.

FIG. 2 is a schematic of the instant invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As used in the disclosure the term legal representative, attorney and agent, attorney of record, agent of record and legal representative of record are used interchangeably to mean a licensed practitioner of the legal filing entity or a recognized legal filing entity such as a state board or federal agency such as the United States Patent Office (USPTO) or Food and Drug Administration (FDA).

As used in the disclosure the term verified lead or lead are used interchangeably and are meant to mean a sales lead is a potential sales contact, individual or organization that expresses an interest in your goods or services. Leads are typically obtained through the referral of an existing customer or through a direct response to advertising or publicity.

As this invention is susceptible to embodiments of many different forms, it is intended that the present disclosure be considered as an example of the principles of the invention and not intended to limit the invention to the specific embodiments shown and described.

The terms leads and request for service are used interchangeably to mean a qualified request from a user of a service of the instant invention.

The terms response, office action, desired service. or filing are used interchangeably to mean a filing by a legal representative to a filing system such as the United States Patent and Trademark office, the Food and Drug administration or Occupational Safety and Health Administration.

One issue with any online system that interfaces with government or large business systems is security. There is a need to ensure that the individual or smart device interacting with the system is a sanctioned user or sanctioned device. The biggest issues in cyber security are:
a. Configuration Mistakes.
b. Poor Cyber Hygiene.
c. Cloud Vulnerabilities.
d. Mobile Device Vulnerabilities.
e. Internet of Things.
f. Ransomware.
g. Poor Data Management.
h. Inadequate Post-Attack Procedures.

The instant invention addresses the problem of Cloud Vulnerabilities and Mobile Device Vulnerabilities. By creating a system that allows access to the systems while ensuring that the devices interacting with the system are sanctioned and allowed to use the system. The instant invention has two methods it can employ to solve the authorized connection problem which is at the heart of any Cloud Vulnerabilities and Mobile Device Vulnerabilities issues. It can use a Global Positioning System (GPS) location filter or an Internet Protocol (IP) address (IP address) filter that allows only those devices that either are from the correct or allowed GPS locations or have the correct IP address. The instant invention can use these filter either individually or in combination to limit access to the system. The instant invention because of these security measures results in a system that can only be implemented with a dedicated network of computerized devices. The dedicated network comprising of a cloud server and remote sanctioned smart devices that have either a validated IP address or are located in a sanctioned location that is verified by the GPS location.

Prior to a discussion of the preferred embodiment of the invention, it should be understood that while the features and advantages of the invention are illustrated in terms of an filing system the invention anticipates using the system for a variety of filing applications.

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to a system and method for generating and developing sales leads for legal services, particularly in the field of intellectual property. The system and method may provide a user-friendly interface that guides potential customers through a do-it-yourself (DIY) data entry process for low-priced intellectual property services such as patent, copyright, or trademark filings. This process may involve the user responding to an advertisement, inputting information related to the desired service, and paying the associated fees.

Upon completion of the data entry and payment process, the system may select a service provider from a list of subscribed service providers. The selected service provider may review the inputted information and submit the corresponding filing to the appropriate office. The system may then provide a nominal payment to the service provider for their filing services.

In some cases, the service provider may become the attorney or agent of record and may receive any notice to respond to any office action generated by the filing. This may create a lead for the service provider, who may then offer additional services to the user. The system and method may thus provide a streamlined and cost-effective way for service providers to generate and develop sales leads, while also offering potential customers an accessible and affordable way to file intellectual property applications.

In some aspects, the system and method may be designed to attract potential clients by offering a discounted price for the initial service of filing an application for a patent, copyright, or trademark. This approach may be particularly effective in the legal services sector, where potential clients often take a considerable amount of time to decide or select a provider. By offering a low-cost entry point into the legal services market, the system and method may be able to capture the interest of potential clients who might otherwise be deterred by the typically high costs of such services.

In some cases, the system may use artificial intelligence and a detailed data entry system to collect information from the user. This information may be formatted into do-it-yourself forms for submission to a service provider. The use of artificial intelligence may help to streamline the data collection process, making it easier for users to input their information and for service providers to review and file the corresponding documents.

In other aspects, the system may select a service provider from a list of subscribed service providers. The selection process may be based on various factors, such as the service provider's expertise in the specific area of intellectual property service, their geographical location, their availability, or other relevant criteria. Once selected, the service provider may review the user's inputted information, submit the corresponding filing, and receive a nominal payment from the system for their services.

In yet other cases, the system may send a notification to the user with the name and contact information of the selected service provider and the filed documents. This notification may serve to inform the user of the status of their filing and to introduce them to the service provider, who may then offer additional services to the user. This approach may provide a direct and cost-effective way for service providers to generate and develop sales leads, as they may be paid for their initial services and also gain a potential client who may require further legal services.

In some aspects, the user device may play a central role in the process of generating legal service leads. The user device may be configured to receive an advertisement for a low-priced intellectual property service. This advertisement may be delivered through various channels, such as online platforms, email, social media, television, radio, or other forms of media. The user device may be any type of electronic device capable of receiving and displaying advertisements, such as a smartphone, a tablet, a laptop, a desktop computer, or other similar devices.

Upon receiving the advertisement, the user may interact with the advertisement on their device. This interaction may involve clicking on a link, scanning a QR code, or performing other actions that direct the user to a data input application. The data input application may be a web-based application, a mobile application, or any other type of application that can guide the user through a do-it-yourself (DIY) data entry process for the desired service.

In some cases, the advertisement may be specifically tailored to attract users interested in low-priced intellectual property services. The advertisement may highlight the affordability of the service, the ease of the DIY data entry process, or other features that may appeal to potential customers. By receiving such an advertisement on their device, the user may be prompted to explore the offered service, thereby initiating the process of generating a legal service lead.

In some aspects, the user may respond to the advertisement by interacting with a data input application. This application may guide the user through a do-it-yourself (DIY) data entry process for the desired service. The data input application may be designed to facilitate the collection of relevant information from the user in a structured and efficient manner. For instance, the application may present a series of prompts or questions to the user, each designed to gather a specific piece of information related to the desired service. The user may input their responses directly into the application, thereby creating a record of the information that can be easily reviewed and processed by the system.

In some cases, the data input application may be configured to guide the user through the DIY data entry process in a step-by-step manner. For example, the application may first prompt the user to select the type of intellectual property service they are interested in, such as patent filing, copyright filing, or trademark filing. The application may then present a series of fields or forms for the user to fill out, each corresponding to a specific piece of information that is relevant to the selected service. The user may input their information into these fields or forms, thereby creating a comprehensive record of their desired service.

In other aspects, the data input application may utilize artificial intelligence to guide the user through the DIY data entry process. The artificial intelligence may be programmed to understand the user's inputs, provide appropriate prompts or suggestions, and ensure that the user's information is correctly and completely inputted. For instance, the artificial intelligence may be able to recognize common errors or omissions in the user's inputs and provide real-time feedback to help the user correct these issues. This may help to streamline the data entry process and improve the accuracy and completeness of the user's information.

In yet other cases, the data input application may be designed to accommodate a variety of user devices. For example, the application may be compatible with smartphones, tablets, laptops, desktop computers, or other types of electronic devices. This may allow users to respond to the advertisement and complete the DIY data entry process using the device that is most convenient for them. The application may also be designed to provide a user-friendly interface that is easy to navigate, regardless of the type of device being used. This may further facilitate the user's interaction with the application and enhance their overall experience with the service.

In some aspects, after the user has inputted their information into the data input application, they may be prompted to check the information for accuracy and completeness. This checking process may involve reviewing each field or form that the user has filled out, verifying that the information is correct, and making any corrections or additions, as necessary. The data input application may provide tools or features to facilitate this checking process, such as highlighting fields that contain errors, providing suggestions for corrections, or allowing the user to easily edit their inputs. In some cases, the data input application may also utilize artificial intelligence to assist in the checking process, such as by automatically detecting and correcting common errors, or by providing real-time feedback to the user.

Once the user has checked their inputted information, they may be prompted to pay the associated service and filing fees. The payment process may be facilitated by a payment module integrated into the system. The payment module may be configured to accept various forms of payment, such as credit cards, debit cards, bank transfers, digital wallets, or other payment methods. In some cases, the payment module may provide a secure and encrypted payment gateway to protect the user's financial information. The payment module may also be configured to calculate the total amount due based on the selected service and any additional fees, and to provide a clear and detailed breakdown of the charges for the user's reference.

In some aspects, the payment module may also handle the distribution of payments to the service provider. For instance, once the user has paid the associated service and filing fees, the payment module may automatically transfer a nominal payment to the service provider for their filing services. This payment may be made directly to the service provider's account, thereby providing a seamless and efficient way for the service provider to receive compensation for their services.

In other cases, the system may also handle the payment of filing fees to the appropriate office. For example, if the user has selected a patent filing service, the system may be configured to pay the filing fees directly to the patent office. This may help to streamline the filing process and ensure that the filing fees are paid in a timely and accurate manner.

In some aspects, the system may include a service provider selection module. This module may be configured to select a service provider from a list of subscribed service providers. The selection process may be based on various factors, such as the service provider's expertise in the specific area of intellectual property service, their geographical location, their availability, or other relevant criteria. The service provider selection module may use algorithms, artificial intelligence, or other computational methods to analyze these factors and select the service provider that is the closest match to the user's requirements.

In some cases, the service provider selection module may be configured to select a service provider automatically, without requiring any input from the user. This may help to streamline the process and ensure that the user is matched with a suitable service provider in a timely manner. In other cases, the service provider selection module may provide the user with a list of potential service providers and allow the user to select their preferred provider. This may give the user more control over the selection process and allow them to choose a service provider that they feel comfortable with.

In yet other aspects, the service provider selection module may be configured to select multiple service providers for a single user request. For example, the module may select a primary service provider to handle the initial filing, and one or more secondary service providers to handle any subsequent actions or services. This may provide a more comprehensive service to the user and ensure that all aspects of their intellectual property filing are handled by experts in the relevant fields.

In some cases, the service provider selection module may also be configured to rotate the selection of service providers. This may ensure that all subscribed service providers have an equal opportunity to be selected and prevent any one provider from being overburdened with requests. The rotation may be based on a predetermined schedule, a random selection process, or other fair and equitable methods.

In other aspects, the service provider selection module may be configured to reselect a service provider if the initially selected provider is unable to fulfill the user's request. For instance, if the selected service provider is unavailable, has a conflict of interest, or does not have the requisite expertise for the user's specific requirements, the module may automatically select another provider from the list. This may ensure that the user's request is handled promptly and efficiently, regardless of any issues with the initially selected provider.

In some aspects, the service provider may play a central role in the process of generating legal service leads. The service provider may be responsible for reviewing and submitting the inputted information provided by the user. This may involve examining the user's DIY data entry forms, verifying the accuracy and completeness of the information, and preparing the corresponding filing for submission to the appropriate office. The service provider may also be responsible for ensuring that the filing complies with all relevant regulations and requirements.

In some cases, the service provider may use their professional expertise and judgment to review the user's inputted information. This may involve checking for any errors or omissions, verifying that the information is consistent with the user's desired service, and making any corrections or adjustments as deemed appropriate. The service provider may also provide feedback to the user, such as suggestions for improving the quality of the information or advice on how to optimize the filing for the desired service.

In other aspects, the service provider may be responsible for submitting the inputted information to the appropriate office. This may involve preparing the corresponding filing, ensuring that all the requisite forms and documents are included, and submitting the filing in accordance with the office's submission procedures. The service provider may also be responsible for tracking the status of the filing and providing updates to the user as appropriate.

In yet other cases, the service provider may be selected from a list of subscribed service providers based on their expertise in the specific area of intellectual property service. For instance, if the user's desired service is a patent filing, the system may select a service provider who specializes in patent law. Similarly, if the user's desired service is a copyright filing, the system may select a service provider who specializes in copyright law. This may ensure that the user's filing is handled by a service provider with the appropriate expertise and experience.

In some aspects, the service provider may also be responsible for responding to any office actions or notices generated by the filing. This may involve reviewing the office action or notice, preparing a response, and submitting the response to the office. The service provider may also communicate with the user regarding the office action or notice and may provide advice or guidance on how to address the issues raised.

In other cases, the service provider may be compensated for their services through a nominal payment provided by the system. This payment may be made upon the successful submission of the user's filing and may serve as a form of compensation for the service provider's time and effort. This approach may provide a cost-effective way for service providers to generate and develop sales leads, as they may be paid for their initial services and also gain a potential client who may require further legal services.

In some aspects, the low-priced intellectual property service that is advertised and offered to the user may be a patent filing service. This service may involve assisting the user in preparing and submitting a patent application to a patent office. The patent filing service may cover various types of patents, such as utility patents, design patents, or plant patents, depending on the user's specific requirements.

In other cases, the low-priced intellectual property service may be a copyright filing service. This service may involve assisting the user in preparing and submitting a copyright registration application to a copyright office. The copyright filing service may cover various types of works, such as literary works, musical works, dramatic works, pictorial works, or audiovisual works, depending on the user's specific requirements.

In yet other aspects, the low-priced intellectual property service may be a trademark filing service. This service may involve assisting the user in preparing and submitting a trademark application to a trademark office. The trademark filing service may cover various types of trademarks, such as word marks, logo marks, or combination marks, depending on the user's specific requirements.

In some cases, the system may be configured to offer multiple types of low-priced intellectual property services. For instance, the system may offer both patent filing services and copyright filing services, and the user may select the service that is the closest match to their specific requirements. This may provide the user with a wider range of options and allow them to choose the service that is the closest match to their specific requirements.

In other aspects, the system may be configured to offer a single type of low-priced intellectual property service, such as patent filing, copyright filing, or trademark filing. This may simplify the user's selection process and allow the system to focus on providing a high-quality service in a specific area of intellectual property law.

In some aspects, the data input application may utilize artificial intelligence to guide the user through the DIY data entry process. The artificial intelligence may be programmed to understand the user's inputs, provide appropriate prompts or suggestions, and ensure that the user's information is correctly and completely inputted. For instance, the artificial intelligence may be able to recognize common errors or omissions in the user's inputs and provide real-time feedback to help the user correct these issues. This may help to streamline the data entry process and improve the accuracy and completeness of the user's information.

In other cases, the artificial intelligence may be designed to adapt to the user's input patterns and preferences. For example, if the user consistently inputs a particular type of information in a specific way, the artificial intelligence may learn from this pattern and adjust its prompts or suggestions accordingly. This may provide a more personalized and user-friendly experience for the user.

In yet other aspects, the artificial intelligence may be configured to provide predictive suggestions based on the user's inputs. For instance, if the user begins to input a particular piece of information, the artificial intelligence may predict what the user is likely to input next and provide a suggestion to expedite the data entry process. This may help to speed up the data entry process and reduce the amount of time the user spends inputting information.

In some cases, the artificial intelligence may be designed to handle complex or multi-step data entry tasks. For example, if the user's desired service involves a multi-step process, the artificial intelligence may guide the user through each step in the correct order, ensuring that all the requisite information is collected and inputted correctly. This may help to simplify complex tasks and make the DIY data entry process more manageable for the user.

In other aspects, the artificial intelligence may be configured to provide assistance or support to the user during the DIY data entry process. For instance, if the user encounters a problem or has a question, the artificial intelligence may provide a solution or answer, or direct the user to a relevant resource for further assistance. This may provide a more supportive and interactive experience for the user, enhancing their overall satisfaction with the service.

In some aspects, the system may be configured to send a notification to the user once the service provider has reviewed and submitted the inputted information. This notification may include the name and contact information of the selected service provider, as well as details of the filed documents. The notification may be sent via various channels, such as email, text message, push notification, or other forms of communication, depending on the user's preferences and the capabilities of the user device.

In some cases, the notification may be generated automatically by the system once the service provider has completed the filing process. The system may be configured to retrieve the relevant information from the service provider and the filed documents, format this information into a notification, and send the notification to the user. This may provide a seamless and efficient way to keep the user informed about the status of their filing and the details of their service provider.

In other aspects, the notification may be customized based on the user's preferences or the specifics of the filed documents. For instance, the notification may include a summary of the filed documents, a link to view the full documents, or other relevant information. The notification may also include a personalized message from the service provider, such as a welcome message, an offer for additional services, or other communications.

In yet other cases, the system may be configured to send multiple notifications to the user at different stages of the filing process. For example, the system may send a first notification when the service provider has been selected, a second notification when the filed documents have been submitted, and a third notification when the filing has been accepted by the office. This may provide the user with regular updates about the progress of their filing and keep them engaged with the service.

In some aspects, the system may also be configured to send notifications to the service provider. These notifications may inform the service provider about the status of the user's filing, any actions or responses that are due, or other relevant information. This may help to keep the service provider informed about their responsibilities and ensure that they are able to provide timely and effective services to the user.

In some aspects, the service provider may assume the role of the attorney or agent of record once they have reviewed and submitted the user's inputted information. As the attorney or agent of record, the service provider may be responsible for receiving any notice to respond to any office action generated by the filing. This may include, for example, notices of allowance, notices of rejection, or other types of official correspondence from the patent, copyright, or trademark office. The service provider may be expected to review these notices, determine the appropriate response, and submit the response to the office within the specified deadline.

In some cases, the service provider may also be responsible for communicating with the user regarding any office actions or notices. This may involve informing the user about the content of the notice, explaining the implications of the notice, and discussing potential responses or strategies. The service provider may also seek the user's input or approval before responding to the notice, particularly if the response involves making substantive changes to the filed documents or incurring additional fees.

In other aspects, the service provider's role as the attorney or agent of record may extend beyond the initial filing process. For instance, if the user's filing results in a granted patent, registered copyright, or registered trademark, the service provider may continue to serve as the attorney or agent of record for the duration of the intellectual property right. This may involve handling any maintenance fees, renewal fees, or other ongoing obligations associated with the intellectual property right.

In yet other cases, the service provider may be able to transfer their role as the attorney or agent of record to another service provider. This may occur, for example, if the user decides to switch service providers, if the service provider is no longer able to fulfill their responsibilities, or if the user's intellectual property rights are sold or transferred to another party. The system may facilitate this transfer process by allowing the user or the service provider to update the attorney or agent of record information and notifying the relevant office of the change.

In some aspects, the service provider's role as the attorney or agent of record may provide a valuable lead generation opportunity. Since the service provider is directly involved in the filing process and is the first point of contact for any office actions or notices, they may be in a prime position to offer additional services to the user. These additional services may include, for example, responding to office actions, prosecuting the application, enforcing the intellectual property right, or providing legal advice or consultation. As such, the service provider may be able to develop a strong relationship with the user and potentially secure future business opportunities.

In some aspects, the system may provide a nominal payment to the service provider for their filing services. This payment may be transferred automatically by the system once the service provider has successfully submitted the user's filing. The amount of the nominal payment may be predetermined and may be the same for all service providers, or it may vary based on factors such as the complexity of the filing, the expertise of the service provider, or other relevant criteria.

In some cases, the nominal payment may be provided as a flat fee for each filing submitted by the service provider. In other cases, the nominal payment may be calculated as a percentage of the service and filing fees paid by the user. The system may be configured to calculate the nominal payment based on the selected calculation method and to transfer the payment to the service provider's account.

In other aspects, the nominal payment may serve as a form of compensation for the service provider's time and effort in reviewing and submitting the user's filing. This may provide an incentive for service providers to participate in the system and to provide high-quality services to the users. The nominal payment may also help to offset the costs incurred by the service provider in the filing process, such as the cost of their time, resources, or any fees or expenses associated with the filing.

In yet other cases, the system may be configured to provide the nominal payment to the service provider immediately upon the successful submission of the user's filing. Alternatively, the system may provide the nominal payment to the service provider at a later time, such as after the filing has been accepted by the office, after the service provider has responded to an office action, or at other predetermined milestones in the filing process.

In some aspects, the system may also be configured to provide additional payments to the service provider for additional services they provide to the user. For instance, if the service provider responds to an office action, prosecutes the application, or provides other legal services to the user, the system may provide additional payments to the service provider for these services. These additional payments may be calculated based on a predetermined fee schedule, a percentage of the user's payment for the additional services, or other suitable calculation methods.

In some aspects, the user device may be a smartphone. Smartphones are portable, handheld devices that combine the functionalities of a computer and a mobile phone. They typically have a touchscreen interface, internet access, and an operating system capable of running downloaded applications. In the context of the present disclosure, a smartphone may be configured to receive an advertisement for a low-priced intellectual property service, respond to the advertisement through a data input application, and process the associated service and filing fees.

In other cases, the user device may be a tablet. Tablets are portable devices that are larger than smartphones and typically have a touchscreen interface. They are designed for internet use, multimedia viewing, and other applications. A tablet may be configured to receive an advertisement for a low-priced intellectual property service, guide the user through a DIY data entry process for the desired service, and process the associated service and filing fees.

In yet other aspects, the user device may be a laptop. Laptops are portable computers that are smaller and lighter than desktop computers. They typically have a clamshell design, with a screen on one side and a keyboard on the other. A laptop may be configured to receive an advertisement for a low-priced intellectual property service, guide the user through a DIY data entry process for the desired service, and process the associated service and filing fees.

In some cases, the user device may be a desktop computer. Desktop computers are personal computers designed for regular use at a single location. They typically have a separate monitor, keyboard, and mouse. A desktop computer may be configured to receive an advertisement for a low-priced intellectual property service, guide the user through a DIY data entry process for the desired service, and process the associated service and filing fees.

In other aspects, the user device may be any other type of electronic device capable of receiving and displaying advertisements, interacting with a data input application, and processing payments. This may include, for example, smart TVs, gaming consoles, wearable devices, or other similar devices. The specific type of user device may depend on various factors, such as the user's preferences, the capabilities of the device, and the requirements of the low-priced intellectual property service.

In some aspects, the process of generating legal service leads may begin with the broadcasting of an advertisement for a low-priced intellectual property service. This advertisement may be disseminated through various channels, such as television, radio, internet, social media platforms, email, or other forms of media. The advertisement may be designed to attract potential customers by highlighting the affordability and accessibility of the intellectual property service. The advertisement may also include a call to action, such as a prompt to visit a website, download an application, or contact a service provider, to encourage potential customers to engage with the service.

In some cases, the advertisement may be specifically tailored to target potential customers who are likely to be interested in the low-priced intellectual property service. This may involve using demographic data, user behavior data, or other relevant information to customize the content, timing, and delivery of the advertisement. The advertisement may also be designed to be visually appealing, informative, and persuasive, to maximize its impact and effectiveness.

In other aspects, upon receiving the advertisement, the user may be directed to a data input application. This application may be configured to guide the user through a do-it-yourself (DIY) data entry process for the desired service. The data input application may provide a user-friendly interface that allows the user to input their information in a structured and efficient manner. The application may present a series of prompts or questions to the user, each designed to gather a specific piece of information related to the desired service.

In some cases, the data input application may utilize artificial intelligence to guide the user through the DIY data entry process. The artificial intelligence may be programmed to understand the user's inputs, provide appropriate prompts or suggestions, and ensure that the user's information is correctly and completely inputted. For instance, the artificial intelligence may be able to recognize common errors or omissions in the user's inputs and provide real-time feedback to help the user correct these issues.

In other aspects, the data input application may be designed to accommodate a variety of user devices. For example, the application may be compatible with smartphones, tablets, laptops, desktop computers, or other types of electronic devices. This may allow users to respond to the advertisement and complete the DIY data entry process using the device that is the easiest and the handiest for them. The application may also be designed to provide a user-friendly interface that is easy to navigate, regardless of the type of device being used. This may further facilitate the user's interaction with the application and enhance their overall experience with the service.

Upon receiving the advertisement, the user may interact with the advertisement on their user device. This interaction may involve clicking on a link, scanning a QR code, or performing other actions that direct the user to a data input application. The data input application may be a web-based application, a mobile application, or any other type of application that can guide the user through a do-it-yourself (DIY) data entry process for the desired service.

In some aspects, the user may respond to the advertisement by initiating a transaction for the low-priced intellectual property service. This transaction may involve selecting the desired service, inputting the relevant information, and confirming the transaction. The user may also be prompted to pay the associated service and filing fees at this stage. The payment process may be facilitated by a payment module integrated into the system.

The payment module may be configured to process various forms of payment, such as credit cards, debit cards, bank transfers, digital wallets, or other payment methods. In some cases, the payment module may provide a secure and encrypted payment gateway to protect the user's financial information. The payment module may also be configured to calculate the total amount due based on the selected service and any additional fees, and to provide a clear and detailed breakdown of the charges for the user's reference.

In some aspects, the payment module may also handle the distribution of payments to the service provider. For instance, once the user has paid the associated service and filing fees, the payment module may automatically transfer a nominal payment to the service provider for their filing services. This payment may be made directly to the service provider's account, thereby providing a seamless and efficient way for the service provider to receive compensation for their services.

In other cases, the system may also handle the payment of filing fees to the appropriate office. For example, if the user has selected a patent filing service, the system may be configured to pay the filing fees directly to the patent office. This may help to streamline the filing process and ensure that the filing fees are paid in a timely and accurate manner.

In yet other aspects, the payment module may be configured to handle refunds or cancellations. For instance, if the user decides to cancel their transaction before the service provider has submitted the filing, the payment module may be configured to refund the user's payment. This may provide a flexible and user-friendly payment process that accommodates the user's changing requirements or circumstances.

In some aspects, the data input application may guide the user through a series of steps designed to collect the information relevant to the desired intellectual property service. For instance, if the user has selected a patent filing service, the application may prompt the user to input information about their patent, such as the title, abstract, description, and claims. The application may also guide the user through the process of preparing drawings or diagrams, if applicable. The user may input their information directly into the application, which may then format the information into a suitable form for submission to the patent office.

In other cases, the data input application may utilize a question-and-answer format to guide the user through the DIY data entry process. The application may present a series of questions to the user, each designed to gather a specific piece of information related to the desired service. The user may input their answers directly into the application, which may then compile the answers into a comprehensive record of the user's information.

In yet other aspects, the data input application may be configured to validate the user's inputted information in real-time. For instance, the application may check the user's inputs for completeness, accuracy, and consistency, and may provide immediate feedback to the user if any issues are detected. This may help to ensure that the user's information is correctly and completely inputted, thereby reducing the likelihood of errors or omissions in the filed documents.

In some aspects, the system may include a service provider selection module. This module may be configured to select a service provider from a list of subscribed service providers. The selection process may be based on various factors, such as the service provider's expertise in the specific area of intellectual property service, their geographical location, their availability, or other relevant criteria. The service provider selection module may use algorithms, artificial intelligence, or other computational methods to analyze these factors and select the service provider that is the closest match to the user's requirements.

In other cases, the service provider selection module may be configured to select a service provider automatically, without requiring any input from the user. This may help to streamline the process and ensure that the user is matched with a suitable service provider in a timely manner. In other cases, the service provider selection module may provide the user with a list of potential service providers and allow the user to select their preferred provider. This may give the user more control over the selection process and allow them to choose a service provider that they feel comfortable with.

In yet other aspects, the service provider selection module may be configured to select multiple service providers for a single user request. For example, the module may select a primary service provider to handle the initial filing, and one or more secondary service providers to handle any subsequent actions or services. This may provide a more comprehensive service to the user and ensure that all aspects of their intellectual property filing are handled by experts in the relevant fields.

In some aspects, the system may include a payment module configured to process the associated service and filing fees. The payment module may be designed to accept various forms of payment, such as credit cards, debit cards, bank transfers, digital wallets, or other payment methods. The payment module may provide a secure and encrypted payment gateway to protect the user's financial information. In some cases, the payment module may also be configured to calculate the total amount due based on the selected service and any additional fees, and to provide a clear and detailed breakdown of the charges for the user's reference.

In other cases, the payment module may handle the distribution of payments to the service provider. For instance, once the user has paid the associated service and filing fees, the payment module may automatically transfer a nominal payment to the service provider for their filing services. This payment may be made directly to the service provider's account, thereby providing a seamless and efficient way for the service provider to receive compensation for their services.

In yet other aspects, the system may also handle the payment of filing fees to the appropriate office. For example, if the user has selected a patent filing service, the system may be configured to pay the filing fees directly to the patent office. This may help to streamline the filing process and ensure that the filing fees are paid in a timely and accurate manner.

In some aspects, the system may include a submission module configured to enable the service provider to review and submit the inputted information. The submission module may provide a user-friendly interface that allows the service provider to easily access, review, and submit the user's inputted information. The submission module may also be configured to track the status of the submission and provide updates to the user and the service provider as appropriate.

In other cases, the submission module may be designed to accommodate a variety of service providers. For example, the submission module may be compatible with service providers who specialize in patent law, copyright law, trademark law, or other areas of intellectual property law. This may allow the system to cater to a wide range of service providers and ensure that the user's filing is handled by a service provider with the appropriate expertise.

In yet other aspects, the submission module may be configured to facilitate the submission of the user's inputted information to the appropriate office. For instance, the submission module may be designed to format the user's inputted information into the appropriate forms or documents for submission to the patent office, copyright office, or trademark office. The submission module may also be configured to automatically submit the formatted information to the appropriate office, thereby streamlining the filing process and reducing the likelihood of errors or omissions.

In some aspects, the system may include a service provider selection module. This module may be configured to select a service provider from a list of subscribed service providers. The selection process may be based on various factors, such as the service provider's expertise in the specific area of intellectual property service, their geographical location, their availability, or other relevant criteria. The service provider selection module may use algorithms, artificial intelligence, or other computational methods to analyze these factors and select the service provider that is the closest match to the user's requirements.

In some cases, the service provider selection module may be configured to select a service provider automatically, without requiring any input from the user. This may help to streamline the process and ensure that the user is matched with a suitable service provider in a timely manner. In other cases, the service provider selection module may provide the user with a list of potential service providers and allow the user to select their preferred provider. This may give the user more control over the selection process and allow them to choose a service provider that they feel comfortable with.

In yet other aspects, the service provider selection module may be configured to select multiple service providers for a single user request. For example, the module may select a primary service provider to handle the initial filing, and one or more secondary service providers to handle any subsequent actions or services. This may provide a more comprehensive service to the user and ensure that all aspects of their intellectual property filing are handled by experts in the relevant fields.

In some aspects, the user device, which may be a smartphone, a tablet, a laptop, or a desktop computer, may play a central role in the process of selecting a service provider. The user device may be configured to display the list of potential service providers, allow the user to select their preferred provider, and transmit the user's selection to the system. The user device may also be configured to receive updates from the system about the status of the service provider selection process, such as notifications about the selected service provider or alerts about any changes or updates to the list of potential service providers.

In some aspects, the service provider may be enabled to review the inputted information through a review module integrated into the system. The review module may provide a user-friendly interface that allows the service provider to easily access, review, and validate the user's inputted information. The review module may also be configured to highlight any errors or omissions in the user's inputs, provide suggestions for corrections, or allow the service provider to easily edit the inputs. This may help to ensure that the user's information is correctly and completely inputted, thereby reducing the likelihood of errors or omissions in the filed documents.

In other cases, the review module may utilize artificial intelligence to assist the service provider in reviewing the user's inputted information. The artificial intelligence may be programmed to understand the user's inputs, detect any inconsistencies or inaccuracies, and provide real-time feedback to the service provider. This may help to streamline the review process and improve the accuracy and completeness of the user's information.

In yet other aspects, the service provider may be enabled to submit the inputted information through a submission module integrated into the system. The submission module may provide a user-friendly interface that allows the service provider to easily submit the user's inputted information to the appropriate office. The submission module may also be configured to format the user's inputted information into the appropriate forms or documents for submission to the patent office, copyright office, or trademark office. The submission module may also be configured to automatically submit the formatted information to the appropriate office, thereby streamlining the filing process and reducing the likelihood of errors or omissions.

In some cases, the submission module may utilize artificial intelligence to assist the service provider in submitting the user's inputted information. The artificial intelligence may be programmed to understand the user's inputs, format the inputs into the appropriate forms or documents, and automatically submit the formatted information to the appropriate office. This may help to streamline the submission process and ensure that the user's filing is submitted in a timely and accurate manner.

In other aspects, the system may be configured to provide feedback to the service provider after the submission of the user's inputted information. This feedback may include a confirmation of the successful submission, a summary of the filed documents, or other relevant information. The system may also be configured to provide feedback to the service provider about any issues or errors detected during the submission process, such as missing information, incorrect formatting, or other issues. This feedback may help the service provider to improve their services and ensure that future submissions are completed accurately and efficiently.

In some aspects, the advertisement for the low-priced intellectual property service may be broadcasted through various mediums. For instance, the advertisement may be broadcasted through television, which may involve airing a commercial or a sponsored program that highlights the service. In some cases, the advertisement may be broadcasted through radio, which may involve airing a radio spot or a sponsored segment that promotes the service.

In other cases, the advertisement may be broadcasted through the internet. This may involve displaying the advertisement on websites, search engines, online forums, or other online platforms. The advertisement may be presented in various formats, such as banner ads, pop-up ads, video ads, or other types of online advertisements. The advertisement may also be targeted to specific users based on their browsing history, search queries, or other online behaviors.

In yet other aspects, the advertisement may be broadcasted through social media platforms. This may involve posting the advertisement on social media sites, sharing the advertisement with social media users, or sponsoring social media content that features the service. The advertisement may be tailored to the specific features and user demographics of each social media platform, thereby maximizing its reach and impact.

In some cases, the advertisement may be broadcasted through email. This may involve sending the advertisement to users who have subscribed to an email list, who have expressed interest in the service, or who have previously used the service. The advertisement may be included in an email newsletter, an email update, or a standalone email campaign.

In other aspects, the system may include a notification module. This module may be configured to send a notification to the user with the name and contact information of the selected service provider and the filed documents. The notification may be sent via various channels, such as email, text message, push notification, or other forms of communication, depending on the user's preferences and the capabilities of the user device.

In some cases, the notification module may be configured to generate the notification automatically once the service provider has filed the documents. The notification may include a summary of the filed documents, a link to view the full documents, or other relevant information. The notification may also include a personalized message from the service provider, such as a welcome message, an offer for additional services, or other communications.

In yet other aspects, the notification module may be configured to send multiple notifications to the user at different stages of the filing process. For example, the module may send a first notification when the service provider has been selected, a second notification when the filed documents have been submitted, and a third notification when the filing has been accepted by the office. This may provide the user with regular updates about the progress of their filing and keep them engaged with the service.

In some aspects, the data input application may include a user interface configured to receive the user's inputted information. The user interface may be designed to be intuitive and user-friendly, making it easy for users to input their information. The user interface may include various input fields, drop-down menus, checkboxes, or other input elements that allow the user to input their information in a structured and organized manner. The user interface may also include help text, tooltips, or other guidance features that assist the user in inputting their information correctly.

In some cases, the user interface may be designed to adapt to the specific requirements of the desired service. For instance, if the user has selected a patent filing service, the user interface may present input fields for the title of the patent, the abstract, the description, and the claims. If the user has selected a copyright filing service, the user interface may present input fields for the title of the work, the author, the year of creation, and other relevant information. This adaptability may allow the data input application to cater to a wide range of intellectual property services, thereby enhancing its utility and versatility.

In other aspects, the user interface may be designed to validate the user's inputted information in real-time. For instance, the user interface may check the user's inputs for completeness, accuracy, and consistency, and may provide immediate feedback to the user if any issues are detected. This real-time validation may help to ensure that the user's information is correctly and completely inputted, thereby reducing the likelihood of errors or omissions in the filed documents.

In yet other cases, the user interface may be designed to guide the user through the DIY data entry process in a step-by-step manner. For example, the user interface may first prompt the user to select the type of intellectual property service they are interested in, such as patent filing, copyright filing, or trademark filing. The user interface may then present a series of fields or forms for the user to fill out, each corresponding to a specific piece of information that is relevant to the selected service. The user may input their information into these fields or forms, thereby creating a comprehensive record of their desired service.

In some aspects, once the service provider has filed the patent, copyright, or trademark filing, the service provider may become the attorney or agent of record. As the attorney or agent of record, the service provider may receive any notice to respond to any office action generated by the filing. This may include, for example, notices of allowance, notices of rejection, or other types of official correspondence from the patent, copyright, or trademark office. The service provider may be expected to review these notices, determine the appropriate response, and submit the response to the office within the specified deadline. This role of the service provider as the attorney or agent of record may provide a valuable lead generation opportunity, as they may be in a prime position to offer additional services to the user.

In some aspects, the data input application may include a user interface that provides prompts to guide the user through the DIY data entry process. These prompts may be designed to assist the user in inputting their information in a structured and organized manner. For instance, the user interface may present a series of prompts or questions to the user, each designed to gather a specific piece of information related to the desired service. The user may input their responses directly into the application, thereby creating a record of the information that can be easily reviewed and processed by the system.

In some cases, the prompts provided by the user interface may be dynamic and adaptive, changing based on the user's inputs or the requirements of the desired service. For example, if the user has selected a patent filing service, the user interface may present prompts related to the title of the patent, the abstract, the description, and the claims. If the user has selected a copyright filing service, the user interface may present prompts related to the title of the work, the author, the year of creation, and other relevant information. This adaptability may allow the data input application to cater to a wide range of intellectual property services, thereby enhancing its utility and versatility.

In other aspects, the user interface may utilize artificial intelligence to generate the prompts. The artificial intelligence may be programmed to understand the user's inputs, determine the appropriate prompts based on the inputs, and present the prompts to the user in a logical and intuitive manner. The artificial intelligence may also be able to recognize common errors or omissions in the user's inputs and adjust the prompts accordingly to help the user correct these issues. This may help to streamline the data entry process and improve the accuracy and completeness of the user's information.

In yet other cases, the user interface may provide visual cues or indicators to guide the user through the DIY data entry process. For instance, the user interface may highlight the current input field, display a progress bar, or provide other visual indicators that help the user understand where they are in the data entry process and what steps they still have to complete. This may provide a more interactive and engaging experience for the user, enhancing their overall satisfaction with the service.

In some aspects, the system may include a payment module configured to provide a nominal payment to the service provider for their filing services. This payment may be transferred automatically by the system once the service provider has successfully submitted the user's filing. The amount of the nominal payment may be predetermined and may be the same for all service providers, or it may vary based on factors such as the complexity of the filing, the expertise of the service provider, or other relevant criteria. The payment module may be configured to calculate the nominal payment based on the selected calculation method and to transfer the payment to the service provider's account. This may provide a seamless and efficient way for the service provider to receive compensation for their services.

In some aspects, after the service provider has reviewed and submitted the user's inputted information, the service provider may be prompted to upload a filing receipt to the system. This filing receipt may serve as a confirmation of the successful submission of the user's filing and may include details such as the filing date, the filing number, or other relevant information. The service provider may upload the filing receipt through a submission module integrated into the system, which may be configured to accept various file formats, such as PDF, JPEG, or other suitable formats.

In some cases, the submission module may provide a user-friendly interface that allows the service provider to easily upload the filing receipt. The interface may include various features, such as a file upload button, a file preview window, or other similar features. The interface may also provide feedback to the service provider about the status of the upload, such as a progress bar, a success message, or an error message.

In other aspects, the system may be configured to automatically process the uploaded filing receipt. For instance, the system may extract relevant information from the filing receipt, such as the filing date or the filing number, and update the user's record accordingly. The system may also generate a notification to inform the user that the filing receipt has been uploaded and that their filing has been successfully submitted.

In yet other cases, the system may be configured to store the uploaded filing receipt in a secure database. This may allow the user, the service provider, or other authorized parties to access the filing receipt at a later time. The system may also be configured to provide various options for managing the stored filing receipt, such as viewing, downloading, printing, or sharing the receipt.

In some aspects, the process of generating legal service leads may begin with the broadcasting of an advertisement for a low-priced intellectual property service. This advertisement may be disseminated through various channels, such as television, radio, internet, social media platforms, email, or other forms of media. The advertisement may be designed to attract potential customers by highlighting the affordability and accessibility of the intellectual property service. The advertisement may also include a call to action, such as a prompt to visit a website, download an application, or contact a service provider, to encourage potential customers to engage with the service.

In some cases, the advertisement may be specifically tailored to target potential customers who are likely to be interested in the low-priced intellectual property service. This may involve using demographic data, user behavior data, or other relevant information to customize the content, timing, and delivery of the advertisement. The advertisement may also be designed to be visually appealing, informative, and persuasive, to maximize its impact and effectiveness.

In some aspects, the system may be configured to send a notification to the user upon receipt of the filing receipt from the service provider. This notification may be generated by a notification module integrated into the system. The notification module may be configured to automatically generate and send the notification once the filing receipt has been uploaded by the service provider. The notification may include details such as the name and contact information of the service provider, the filing date, the filing number, or other relevant information. The notification may be sent via various channels, such as email, text message, push notification, or other forms of communication, depending on the user's preferences and the capabilities of the user device.

In some cases, the notification module may be configured to customize the notification based on the user's preferences or the specifics of the filed documents. For instance, the notification may include a summary of the filed documents, a link to view the full documents, or other relevant information. The notification may also include a personalized message from the service provider, such as a welcome message, an offer for additional services, or other communications.

In other aspects, the notification module may be configured to send multiple notifications to the user at different stages of the filing process. For example, the module may send a first notification when the service provider has been selected, a second notification when the filed documents have been submitted, and a third notification when the filing receipt has been uploaded by the service provider. This may provide the user with regular updates about the progress of their filing and keep them engaged with the service.

In yet other cases, the system may be configured to send notifications to the service provider as well. These notifications may inform the service provider about the status of the user's filing, any actions or responses that are due, or other relevant information. This may help to keep the service provider informed about their responsibilities and ensure that they are able to provide timely and effective services to the user.

In some aspects, the selection of a service provider may be based on a variety of criteria. For instance, the system may consider the geographical location of the service provider. This could be particularly relevant if the user prefers to work with a service provider in their local area, or if the intellectual property service involves legal proceedings or requirements that are specific to a particular jurisdiction. In such cases, the system may be configured to prioritize service providers who are located in the same city, state, or country as the user.

In other cases, the system may consider the expertise of the service provider in the specific area of intellectual property service. For instance, if the user's desired service is a patent filing, the system may prioritize service providers who specialize in patent law. Similarly, if the user's desired service is a copyright filing, the system may prioritize service providers who specialize in copyright law. This may ensure that the user's filing is handled by a service provider with the appropriate expertise and experience.

In yet other aspects, the system may consider the availability of the service provider. For instance, the system may prioritize service providers who are currently available to take on new clients, who have a quick turnaround time, or who can accommodate the user's preferred timeline. The system may be configured to check the availability of each service provider in real-time, or it may rely on availability information provided by the service providers themselves.

In some cases, the system may consider other relevant criteria when selecting a service provider. For instance, the system may consider the service provider's reputation, their fee structure, their language capabilities, or other factors that may be relevant to the user's specific requirements or preferences. The system may be configured to weigh these criteria according to a predetermined algorithm, or it may allow the user to specify their own preferences or priorities.

In other aspects, the system may select a service provider based on a combination of these criteria. For instance, the system may first filter the list of service providers based on their geographical location, then further narrow down the list based on their expertise and availability. This may allow the system to select a service provider who is not just a close match to the user's requirements, but also the closest match among all available service providers.

In yet other cases, the system may allow the user to override the automatic selection of a service provider. For instance, the user may choose to work with a specific service provider, regardless of their geographical location, expertise, or availability. In such cases, the system may be configured to accommodate the user's preference and assign the selected service provider to handle the user's filing.

A number of implementations have been described. Nevertheless, it will be understood that various modifications may be made without departing from the spirit and scope of the disclosure. Accordingly, other implementations are within the scope of the following claims.

The instant invention can further be described as A method for free lead generation wherein a user device receives an advertisement advertising a low-priced intellectual property service comprising:
a. the user device responds to the advertisement;
b. a data input application that guides the user through a do-it-yourself (DIY) data entry for the service that user desires;
c. the user checks the inputted information and pays the fees associated with the service and the filing fees;
d. the system sends the inputted information to the system;
e. the system selects a service provider;
f. the service provider reviews the inputted information;
g. the service provider submits the inputted information;
h. The receiving office responds to the inputted information;
i. The service provider submits a proposal for a response to the system;
j. The system sends the proposal to the user;
k. The user authorizes the service provider to respond and pays the fee;
l. The service provider response to the response from the receiving office and collects the fee.

In a first implementation of the invention a user device receives an advertisement advertising a low-priced intellectual property service such as a patent, copyright, or trademark filing. The low-priced service is only for the initial service of filing the patent, copyright, or trademark filing. The potential customer with the user device responds to the advertisement and is directed to a data input application that guides the applicant through a do-it-yourself (DIY) data entry for the particular intellectual property service that customer desires. Once the user has inputted the information the user then checks it and pays the fees associated with the service and the filing fees with either the patent office, trademark office or copyright office.

Once the fees have been paid the service selects a service provider who reviews the DIY submission and files the patent, copyright, or trademark filing. Once the service provider has filed the patent, copyright or trademark filing the system then sends a notification of the name and contact information of the service provider and the filed documents to the user. The system the provides a nominal payment to the service provider for their filing services.

The service provider is now the attorney or agent of record and will receive any notice to respond to any office action generated by the filing. This is a lead that is a user who needs the service of the service provider, and the lead does not cost the service provider any fee. The benefit t=of the system is that the service provider has actually been paid a nominal fee instead of paying for a lead and they get the follow up lead directly from the servicing patent, copyright, or trademark office.

As is well known, generating a sales lead is an expensive and indirect method of getting a client. Typically leads may not generate a sale because the user identified in the lead may not need the service or they are still looking for what service they actually need. This process is complicated for legal services because of the duration of time most potential clients take to decide or select a provider.

The system captures the potential client by offering a discounted price for the simple service of filing the application for a patent, copyright, or trademark filing. The system uses Artificial Intelligence and a detailed data entry system to collect the information from the user and formats the Do-It Yourself forms for submission to a service provider.

The system then selects a service provider from a list of subscribed service providers and send the service request and associated documents to the service provider.

The service provider then reviews and files the documents. The service provider uploads a filing receipt and collects a nominal fee.

An alternative instant invention can be described as a method for generating legal service leads, comprising:
a. receiving an advertisement for a low-priced intellectual property service on a user device;
b. responding to the advertisement through a data input application that guides the user through a do-it-yourself (DIY) data entry for the desired service;
c. checking the inputted information and paying the associated service and filing fees;
d. selecting a service provider through the system;
e. reviewing the inputted information by the service provider; and
f. submitting the inputted information by the service provider.

The method of the alternative instant invention, wherein the low-priced intellectual property service is selected from the group consisting of patent filing, copyright filing, and trademark filing.

The method of the alternative instant invention, wherein the data input application utilizes artificial intelligence to guide the user through the DIY data entry.

The method of the alternative instant invention further comprising sending a notification to the user with the name and contact information of the selected service provider and the filed documents.

The method of alternative instant invention, wherein the service provider becomes the attorney or agent of record and receives any notice to respond to any office action generated by the filing.

The method of the instant invention, further comprising providing a nominal payment to the service provider for their filing services.

A second alternative instant invention can be described as a system for generating legal service leads, comprising:
a. a user device configured to receive an advertisement for a low-priced intellectual property service;
b. a data input application configured to guide the user through a do-it-yourself (DIY) data entry for the desired service;
c. a payment module configured to process the associated service and filing fees;
d. a service provider selection module configured to select a service provider; and
e. a submission module configured to enable the service provider to review and submit the inputted information.

The system of the second alternative instant invention, wherein the user device is selected from the group consisting of a smartphone, a tablet, a laptop, and a desktop computer.

The system of the second alternative instant invention, wherein the data input application utilizes artificial intelligence to guide the user through the DIY data entry.

The system of the second alternative instant invention, further comprising a notification module configured to send a notification to the user with the name and contact information of the selected service provider and the filed documents.

The system of the second alternative instant invention, wherein the service provider becomes the attorney or agent of record and receives any notice to respond to any office action generated by the filing.

The system of the second alternative instant invention, further comprising a payment module configured to provide a nominal payment to the service provider for their filing services.

The system of the second alternative instant invention, wherein the low-priced intellectual property service is selected from the group consisting of patent filing, copyright filing, and trademark filing.

A third alternative instant invention can be described as a computer-implemented method for generating legal service leads, comprising:
a. broadcasting an advertisement for a low-priced intellectual property service;
b. receiving a response to the advertisement from a user device;
c. guiding the user through a do-it-yourself (DIY) data entry for the desired service via a data input application;
d. processing the associated service and filing fees;
e. selecting a service provider from a list of subscribed service providers; and
f. enabling the service provider to review and submit the inputted information.

A third alternative instant invention can be described as a method of the instant invention, wherein the advertisement is broadcasted through a medium selected from the group consisting of television, radio, internet, social media platforms, and email.

The method of the third alternative instant invention, wherein the data input application includes a user interface configured to receive the user's inputted information.

The method of the third alternative instant invention, wherein the user interface is configured to provide prompts to the user to guide the user through the DIY data entry.

The method of the third alternative instant invention, further comprising the step of the service provider uploading a filing receipt to the system after submitting the inputted information.

The method of the third alternative instant invention, wherein the system is configured to send a notification to the user upon receipt of the filing receipt from the service provider.

The method of the third alternative instant invention, wherein the service provider is selected based on criteria including at least one of: geographical location, expertise in the specific area of intellectual property service, and availability.

A fourth alternative method for generating legal service leads, comprising:
a. a cloud server having a cloud server application and a sanction IP address database, and the sanction IP address database is used by the cloud server as a third layer of security to access the cloud server;
b. a company user using a company smart device having a company security application and the company user uses the company security application to log into the company smart device using a company login name and company login password and the company user using company smart device application submits a company login name and a company login password and the company smart device application submits the company smart device IP address to the cloud server and the cloud server application checks the company login name, company login password and the company smart device IP address and if the company smart device IP address is in the sanctioned IP address database on the cloud server the cloud server application processes the company login name and company login password and if the company login name and company login password are in sanctioned IP address database the cloud allows the company smart device to transfer data to the cloud server application and the company user creates an a low-priced intellectual property service advertisement and the submits the low-priced intellectual property service advertisement to the cloud server application;
c. a client user using a client smart device having a client security application and the client user uses the client security application to log into the client smart device using a client login name and client login password and the client user using client smart device application submits the client login name and client login password and the client smart device application submits the client smart device IP address to the cloud server and the cloud server application checks the client login name, client login password and the client smart device IP address and if the client smart device IP address is in the sanctioned IP address database on the cloud server the cloud server application processes the client login name and client login password and if the client login name and client login password are in sanctioned IP address database the cloud allows the client smart device to transfer data to the cloud server application;
d. the client smart device having a client smart device application and the client smart device application displaying the advertisement using a client smart device application and a client user responding to the low-priced intellectual property service advertisement using the client smart device application that guides the user through a do-it-yourself (DIY) data entry to create input for an intellectual property service advertised in the low-priced intellectual property service advertisement;
e. a legal representative using a legal representative smart device having a legal representative security application and the legal representative user uses the legal representative security application to log into the legal representative smart device using a legal representative login name and legal representative login password and the legal representative user using legal representative smart device application submits the legal representative login name and legal representative login password and the legal representative smart device application submits the legal representative smart device IP address to the cloud server and the cloud server application checks the legal representative login name, legal representative login password and the legal representative smart device IP address and if the legal representative smart device IP address is in the sanctioned IP address database on the cloud server the cloud server application processes the legal representative login name and legal representative login password and if the legal representative login name and legal representative login password are in the sanctioned IP address database the cloud server application allows the client smart device to transfer data to the cloud server application;
f. the client smart device having a client smart device applications sends the create input for an intellectual property service advertised and a client fee to a cloud server having a cloud server application and the cloud service application sends the input for the intellectual property service advertised to the legal representative smart device and the legal representative smart device application receiving input for an intellectual property service advertised and a legal representative fee which is a split of the client fee;
g. the legal representative using a legal representative smart device having the legal representative application creates a legal filing from the input for an intellectual property service advertised and legal representative application files the input for an intellectual property service advertised with a legal filing entity and pays the filing service fee to the legal filing entity and the filing fee is a split of the legal representative fee and the legal filing entity transfers a filing receipt to the a legal representative application and the a legal representative application transfers the legal filing and filing receipt to the cloud server and cloud server application and the cloud server application transfers a legal representative fee and the legal representative fee is a split of the client fee and the cloud application transfers the legal filing and the filing receipt to the client smart device application; and
h. the client user is now the registered client of the legal representative.

The alternative method of the instant invention, wherein the low-priced intellectual property service is selected from the group consisting of patent filing, copyright filing, and trademark filing.

The fourth alternative method of the instant invention, wherein the data input application utilizes artificial intelligence to guide the user through the DIY data entry.

The fourth alternative method of the instant invention, further comprising sending a notification to the client user with the name and contact information of the selected service provider and the legal filing and filing receipt.

The fourth alternative method of the instant invention, wherein the service provider becomes the attorney or agent of record and receives any notice to respond to any office action generated by the filing.

The fourth alternative method of the instant invention, further comprising providing a nominal fee to the legal representative for their filing services.

Since most government systems require attorney or agent of record the instant invention provides this by having a licensed professional such as the legal representative file the documents. The system provides two unique benefits. The first is a lower cost submission for the client, second benefit is the filing of the client's documents by a licensed legal representative and the third is the legal representative getting paid for filing and also being the attorney or agent of record for the client with respect to the documents that were filed by the legal representative. This process means that the legal representative gets paid to file and because of the filing get to be the attorney or agent of record for the client thereby getting a verified lead for any future transactions between the client and the legal filing entity.

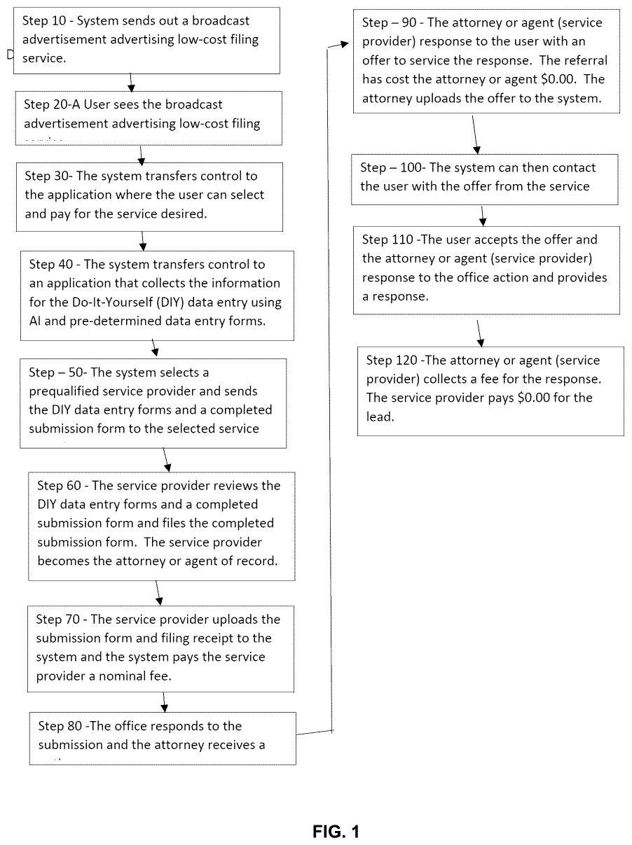

Referring now to the drawings FIG. 1, there is shown a flowchart of the instant invention.

Step 10 The system sends out a broadcast advertisement advertising low-cost filing service.

Step 20 A User sees the broadcast advertisement advertising low-cost filing service.

Step 30 The system transfers control to the application where the user can select and pay for the service desired.

Step 40 The system transfers control to an application that collects the information for the Do-It-Yourself (DIY) data entry using AI and pre-determined data entry.

Step 50 The system selects a prequalified service provider and sends the DIY data entry forms and a completed submission form to the selected service provider.

Step 60 The service provider reviews the DIY data entry forms and a completed submission form and files the completed submission form. The service provider becomes the attorney or agent of record.

Step 70 The service provider uploads the submission form and filing receipt to the system and the system pays the service provider a nominal fee.

Step 80 The office responds to the submission and the attorney receives a notice. [0043].

Step 90 The attorney or agent (service provider) response to the user with an offer to service the response. The referral has cost the attorney or agent $0.00. The attorney uploads the offer to the system.

Step 100 The system can then contact the user with the offer from the service provider.

Step 110 The user accepts the offer and the attorney or agent (service provider) response to the office action and provides a response.

Step 120 The attorney or agent (service provider) collects a fee for the response.

The service provider pays $0.00 for the lead.

The result is the attorney or agent service provider is actually paid for the lead instead of having to pay for the lead and gets a real lead for a client having a need for their services for free.

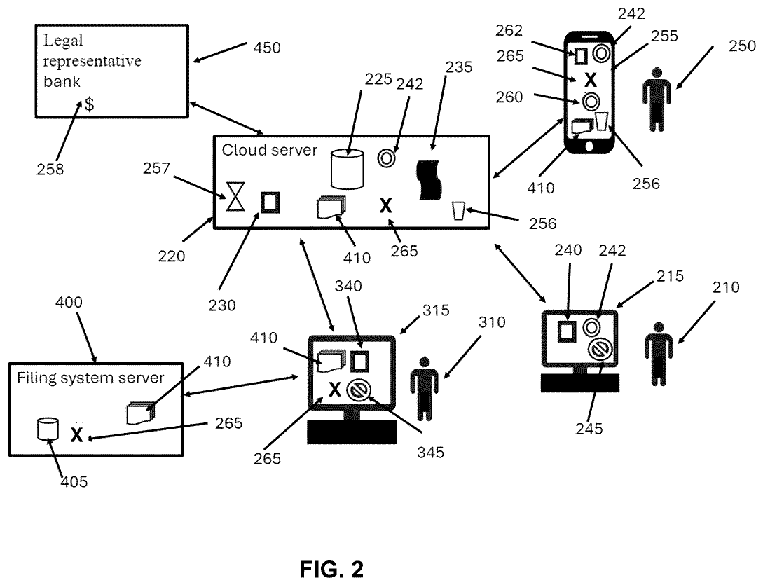

FIG. 2 there is shown a schematic of the instant invention. Company user 210 has a company smart system 215 and company smart system 215 has a company application 240 that is used to create advertisement 242. Company smart system 215 also has a company IP address 245.

When the advertisement 242 is complete the company user 210 uses the company application 240 to log into the cloud application 230 on cloud server 220. Cloud server 220 has memory 225 where the cloud application 230 and the sanction list 235 is stored. The company application 240 sends the company IP address 245 to cloud server 220 and the cloud application 230 compares the company IP address 245 to those contained in sanction list 235. If there is a match the cloud server application 230 allows company application 230 to log into the cloud application 230 using a password and username.

Once the company application 240 is logged in to the server application 230 the company application 240 uploads the advertisement 242 and the cloud application 230 sends the advertisement 242 to at least one client user 250 client smart device 255. The at last one client user 250 responds to the advertisement 242 using client smart device 255 and client smart device application 262 and creates a DIY file 265. Once DIY file 265 is complete the client smart device application 262 sends the client IP address 260 to cloud server 220 and the cloud application 230 compares the client IP address 260 to those contained in sanction list 235. If there is a match the cloud server application 230 allows client smart device application 262 to log into the cloud application 230 using a password and username.

The client smart device application 262 then transfers the DIY file 265 and payment 256 to the cloud application 230 and the cloud application 230 selects a legal representative 310. The cloud application 230 calculates the legal representative payment 257 and stores it in memory 225.

Legal representative 310 has a legal representative smart device 315 the legal representative 310 uses the legal representative application 340 to log into the cloud application 230 on cloud server 220. Cloud server 220 has memory 225 where the cloud application 230 and the sanction list 235 is stored. The legal representative application 340 sends the legal representative IP address 345 to cloud server 220 and the cloud application 230 compares the legal representative IP address 345 to those contained in sanction list 235. If there is a match the cloud server application 230 allows legal representative application 330 to log into the cloud application 230 using a password and username.

Once the legal representative application 340 is log in to the cloud application 230 the cloud application 230 transfers the DIY file 265 to the legal representative application 340 and the legal representative 310 reviews the DIY file 265. The legal representative 310 then logs into the Filing system server 400 and transfers the DIY file 265 to the filing system server 400 filing system storage 405. The filing system server 400 transfers a filling receipt 410 to legal representative application 340.

The legal representative 310 logs out of the Filing system server 400 and using the legal representative application 340 transfers the filling receipt 410 to the cloud application 230 and the cloud application 230 transfers filling receipt 410 to the client smart device application 262 and transfers a payment 258 in the amount of legal representative payment 257 to legal representative bank 450.

The legal representative smart device 315, client smart device 255, cloud server 220 and company smart system 215 are connected by either a wired or wireless network. The wired network can be ethernet or another suitable network, the wireless network can comprise of WI/FI, 3G, 5G, LTE, Bluetooth, ZigBee or any suitable wireless network and network protocol.

The present disclosure provides a GPS device designed specifically for tracking the location of a client smart device 255 and the legal representative smart device 315. This GPS device may include various components that work together to accurately determine and monitor the position of the client smart device 255 and the legal representative smart device 315. The GPS device may be attached to the client smart device 255 and the legal representative smart device 315, enabling real-time tracking of the client smart device 255 and the legal representative smart device 315 location. The GPS device may utilize satellite signals to determine the precise location of the client smart device 255 and the legal representative smart device 315 and may relay this information to a user or cloud application through a variety of means, such as a mobile application or a web-based platform. In some cases, the GPS device may also include features that allow for historical tracking data to be stored and accessed, providing a record of the client smart device 255 and the legal representative smart device 315 movements over time. This GPS device may offer a solution for individuals who frequently misplace their client smart device 255 and the legal representative smart device 315 providing a convenient and efficient means of locating the item when it is not immediately visible or accessible.

In some embodiments the client smart device 255 and the legal representative smart device 315 can have a GPS location device. The GPS location can be used as a second tier security method where as the client smart device 255 and the legal representative smart device 315 send the GPS location determined from the respective GPS location device and the cloud application 230 checks the GPS location transferred from the client smart device 255 and the legal representative smart device 315 with a sanction list of GPS locations on the cloud server and if the GPS location sent from the client smart device 255 or the legal representative smart device 315 is contained in the sanction list of GPS locations on the cloud server 220 then the cloud application 230 allows the client smart device 255 or the legal representative smart device 315 to initiate the transfer of information. If the GPS location sent by the client smart device 255 or the legal representative smart device 315 is not contained on the sanction list of GPS locations on the cloud server 220 then the cloud application 230 does not allows the client smart device 255 or the legal representative smart device 315 to initiate the transfer of information.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI), or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above-described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for generating legal service leads, comprising:
a. a cloud server having a cloud server application and a sanction IP address database, and the sanction IP address database is used by the cloud server as a third layer of security to access the cloud server;
b. a company user using a company smart device having a company security application and the company user uses the company security application to log into the company smart device using a company login name and company login password and the company user using company smart device application submits a company login name and a company login password and the company smart device application submits the company smart device IP address to the cloud server and the cloud server application checks the company login name, company login password and the company smart device IP address and if the company smart device IP address is in the sanctioned IP address database on the cloud server the cloud server application processes the company login name and company login password and if the company login name and company login password are in sanctioned IP address database the cloud allows the company smart device to transfer data to the cloud server application and the company user creates an a low-priced intellectual property service advertisement and the submits the low-priced intellectual property service advertisement to the cloud server application;
c. a client user using a client smart device having a client security application and the client user uses the client security application to log into the client smart device using a client login name and client login password and the client user using client smart device application submits the client login name and client login password and the client smart device application submits the client smart device IP address to the cloud server and the cloud server application checks the client login name, client login password and the client smart device IP address and if the client smart device IP address is in the sanctioned IP address database on the cloud server the cloud server application processes the client login name and client login password and if the client login name and client login password are in sanctioned IP address database the cloud allows the client smart device to transfer data to the cloud server application;
d. the client smart device having a client smart device application and the client smart device application displaying the advertisement using a client smart device application and a client user responding to the low-priced intellectual property service advertisement using the client smart device application that guides the user through a do-it-yourself (DIY) data entry to create input for an intellectual property service advertised in the low-priced intellectual property service advertisement;
e. a legal representative using a legal representative smart device having a legal representative security application and the legal representative user uses the legal representative security application to log into the legal representative smart device using a legal representative login name and legal representative login password and the legal representative user using legal representative smart device application submits the legal representative login name and legal representative login password and the legal representative smart device application submits the legal representative smart device IP address to the cloud server and the cloud server application checks the legal representative login name, legal representative login password and the legal representative smart device IP address and if the legal representative smart device IP address is in the sanctioned IP address database on the cloud server the cloud server application processes the legal representative login name and legal representative login password and if the legal representative login name and legal representative login password are in the sanctioned IP address database the cloud server application allows the client smart device to transfer data to the cloud server application;
f. the client smart device having a client smart device applications sends the create input for an intellectual property service advertised and a client fee to a cloud server having a cloud server application and the cloud service application sends the input for the intellectual property service advertised to the legal representative smart device and the legal representative smart device application receiving input for an intellectual property service advertised and a legal representative fee which is a split of the client fee;
g. the legal representative using a legal representative smart device having the legal representative application creates a legal filing from the input for an intellectual property service advertised and legal representative application files the input for an intellectual property service advertised with a legal filing entity and pays the filing service fee to the legal filing entity and the filing fee is a split of the legal representative fee and the legal filing entity transfers a filing receipt to the a legal representative application and the a legal representative application transfers the legal filing and filing receipt to the cloud server and cloud server application and the cloud server application transfers a legal representative fee and the legal representative fee is a split of the client fee and the cloud application transfers the legal filing and the filing receipt to the client smart device application; and
h. the client user is now the registered client of the legal representative.

2. The method of claim 1, wherein the low-priced intellectual property service is selected from the group consisting of patent filing, copyright filing, and trademark filing.

3. The method of claim 1, wherein the data input application utilizes artificial intelligence to guide the user through the DIY data entry.

4. The method of claim 1, further comprising sending a notification to the client user with the name and contact information of the selected service provider and the legal filing and filing receipt.

5. The method of claim 4, wherein the service provider becomes the attorney or agent of record and receives any notice to respond to any office action generated by the filing.

6. The method of claim 1, further comprising providing a nominal fee to the legal representative for their filing services.

7. A system for generating legal service leads, comprising:
a. a user device configured to receive an advertisement for a low-priced intellectual property service;
b. a data input application configured to guide the user through a do-it-yourself (DIY) data entry for the desired service;
c. a payment module configured to process the associated service and filing fees;
d. a service provider selection module configured to select a service provider; and
e. a submission module configured to enable the service provider to review and submit the inputted information.

8. The system of claim 7, wherein the user device is selected from the group consisting of a smartphone, a tablet, a laptop, and a desktop computer.

9. The system of claim 7, wherein the data input application utilizes artificial intelligence to guide the user through the DIY data entry.

10. The system of claim 7, further comprising a notification module configured to send a notification to the user with the name and contact information of the selected service provider and the filed documents.

11. The system of claim 10, wherein the service provider becomes the attorney or agent of record and receives any notice to respond to any office action generated by the filing.

12. The system of claim 7, further comprising a payment module configured to provide a nominal payment to the service provider for their filing services.

13. The system of claim 7, wherein the low-priced intellectual property service is selected from the group consisting of patent filing, copyright filing, and trademark filing.

14. A computer-implemented method for generating legal service leads, comprising:
a. broadcasting an advertisement for a low-priced intellectual property service;
b. receiving a response to the advertisement from a user device;
c. guiding the user through a do-it-yourself (DIY) data entry for the desired service via a data input application;
d. processing the associated service and filing fees;
e. selecting a service provider from a list of subscribed service providers; and
f. enabling the service provider to review and submit the inputted information.

15. The method of claim 14, wherein the advertisement is broadcasted through a medium selected from the group consisting of television, radio, internet, social media platforms, and email.

16. The method of claim 14, wherein the data input application includes a user interface configured to receive the user's inputted information.

17. The method of claim 16, wherein the user interface is configured to provide prompts to the user to guide the user through the DIY data entry.

18. The method of claim 14, further comprising the step of the service provider uploading a filing receipt to the system after submitting the inputted information.

19. The method of claim 18, wherein the system is configured to send a notification to the user upon receipt of the filing receipt from the service provider.

20. The method of claim 14, wherein the service provider is selected based on criteria including at least one of: geographical location, expertise in the specific area of intellectual property service, and availability.
